(19) United States
(12) Patent Application Publication
(10) Pub. No.: US 2023/0393347 A1
(43) Pub. Date: Dec. 7, 2023

(54) CONNECTOR ASSEMBLY FOR FIBER OPTIC CABLE

(71) Applicant: AFL Telecommunications LLC, Duncan, SC (US)

(72) Inventor: Jonathan Fang, Simpsonville, SC (US)

(21) Appl. No.: 18/206,336

(22) Filed: Jun. 6, 2023

Related U.S. Application Data
(60) Provisional application No. 63/349,331, filed on Jun. 6, 2022.

(51) Int. Cl. G02B 6/38

(52) U.S. Cl. CPC G02B 6/3825; G02B 6/3897; G02B 6/3881; G02B 6/3885; G02B 6/3894

(57) ABSTRACT

A fiber optic cable assembly and fiber optic connector assembly are provided. The connector assembly includes a first and second middle body each forming open ends through which an optical fiber is extendable along a longitudinal direction. The second middle body forms an inner body configured to extend into the first middle body. A connector body is configured to retain a fiber optic connector. The connector body is coupled respectively to the first and second middle bodies. An outer body extends along the longitudinal direction and is configured to couple to the connector body and respective first and second middle bodies. The outer body is configured to surround a mating interface at which the connector body abuts to respective first and second middle bodies.

### PRIORITY STATEMENT

The present application claims the benefit of priority to U.S. provisional patent application Ser. No. 63/349,331, filed Jun. 6, 2022, the disclosure of which is incorporated by reference herein in its entirety.

### FIELD

The present disclosure relates generally to fiber optic communications networks, and more particularly to fiber optic connectors and drop cable assemblies for use in fiber optic communications networks.

### BACKGROUND

Optical fiber is increasingly being used for a variety of applications, including broadband applications such as voice, video and data transmissions. As a result of this increasing demand, fiber optic networks typically include a large number of mid-span access locations at which one or more optical fibers are branched from a distribution cable. These mid-span access locations provide a branch point from the distribution cable and may lead to an end user, commonly referred to as a subscriber. Fiber optic networks which provide such access are commonly referred to as FTTX “fiber to the X” networks, with X indicating a delivery point such as a home (i.e., FTTH).

Drop cables are utilized to connect the end user to the distribution cable and thus the fiber optic network. For example, multi-port optical connection terminals have been developed for interconnecting drop cables with a fiber optic distribution cable at a predetermined branch point in a fiber optic network between a mid-span access location on the distribution cable and a delivery point such as a subscriber premises. Utilizing such terminals, drop cables extending from a delivery point may be physically connected to the communications network at the branch point provided by such terminals as opposed to at the actual mid-span access location provided on the distribution cable. Alternatively, however, drop cables may connect to the distribution cable at the mid-span access location.

Multi-port optical connection terminals, from which single-fiber drop cables extend to a subscriber, are required to meet standards for outside plant (OSP) environmental conditions while also facilitating network extension to the subscriber. Generally, larger connection terminals require larger and more complex structures for mounting, or may require greater volumes or spaces at a utility pole, underground volume, or other appropriate structure. Such spaces may be rented, and accordingly, rent costs may vary directly based on size and complexity of the connection terminal.

Accordingly, improved drop cable assemblies and connection assemblies for fiber optic communications networks would be advantageous. In particular, improved fiber optic drop cable assemblies and fiber optic connector assemblies for fiber to the X at a telecommunications network are desired. Still particularly, fiber optic connector assemblies for extending drop cable assemblies are desired.

### BRIEF DESCRIPTION

Aspects and advantages of the cable support devices and assemblies in accordance with the present disclosure will be set forth in part in the following description, or may be obvious from the description, or may be learned through practice of the technology.

An aspect of the present disclosure is directed to a fiber optic connector assembly. The fiber optic connector assembly defines a first end and a second end each separated along a longitudinal direction corresponding to a longitudinal extension of a cable. The fiber optic connector assembly includes a first middle body extending along the longitudinal direction. The first middle body forms open ends through which an optical fiber is extendable along the longitudinal direction. A second middle body extends along the longitudinal direction. The second middle body forms open ends through which the optical fiber is extendable along the longitudinal direction. The second middle body forms an inner body configured to extend into the first middle body. A connector body is configured to retain a fiber optic connector along the longitudinal direction. The connector body is coupled respectively to the first middle body and the second middle body. An outer body extends along the longitudinal direction. The outer body is configured to couple to the connector body and respective first middle body and second middle body. The outer body is configured to surround a mating interface at which the connector body abuts to respective first middle body and second body.

Another aspect of the present disclosure is directed to a fiber optic cable assembly. The fiber optic cable assembly defines a first end and a second end each separated along a longitudinal direction. The fiber optic cable assembly includes a first fiber optic cable extending from the first end and a second fiber optic cable extending from the second end. A connector assembly is configured to receive the first fiber optic cable at the first end and the second fiber optic cable at the second end. The connector assembly includes a first middle body, a second middle body, a first connector body, a second connector body, a first outer body, and a second outer body. The first middle body forms open ends through which an optical fiber is extendable along the longitudinal direction. The second middle body forms open ends through which the optical fiber is extendable along the longitudinal direction. The second middle body forms an inner body configured to extend into the first middle body and couple to the first middle body. The first connector body is configured to retain a first fiber optic connector along the longitudinal direction. The first connector body is coupled to the first middle body. The first outer body is configured to couple to the first connector body and the first middle body. The first outer body is configured to surround a first mating interface at which the first connector body abuts to the first middle body. The second connector body is configured to retain a second fiber optic connector along the longitudinal direction. The second connector body is coupled to the second middle body. The second outer body is configured to couple to the second connector body and the second middle body. The second outer body is configured to surround a second mating interface at which the second connector body abuts to the second middle body.

These and other features, aspects and advantages of the present cable support devices and assemblies will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION

A full and enabling disclosure of the present cable support devices and assemblies, including the best mode of making and using the present systems and methods, directed to one of ordinary skill in the art, is set forth in the specification, which makes reference to the appended figures, in which:

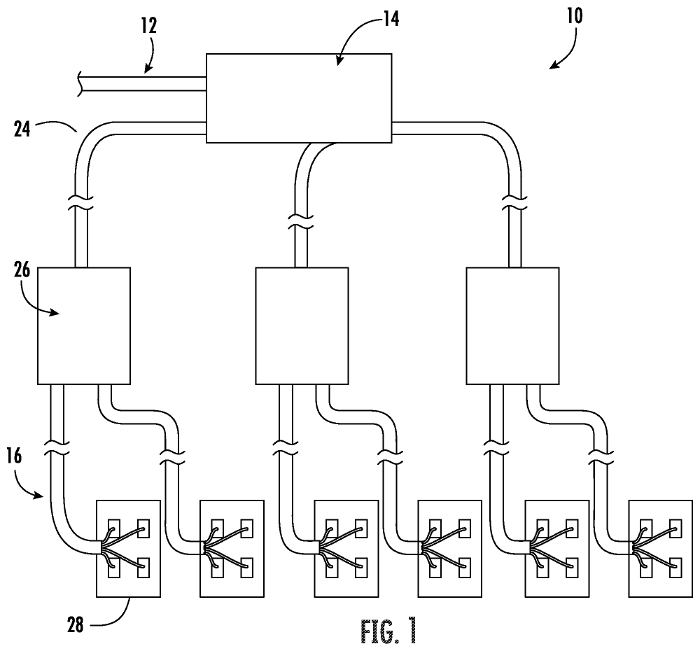

FIG. 1 is a schematic illustration of a fiber optic communications network;

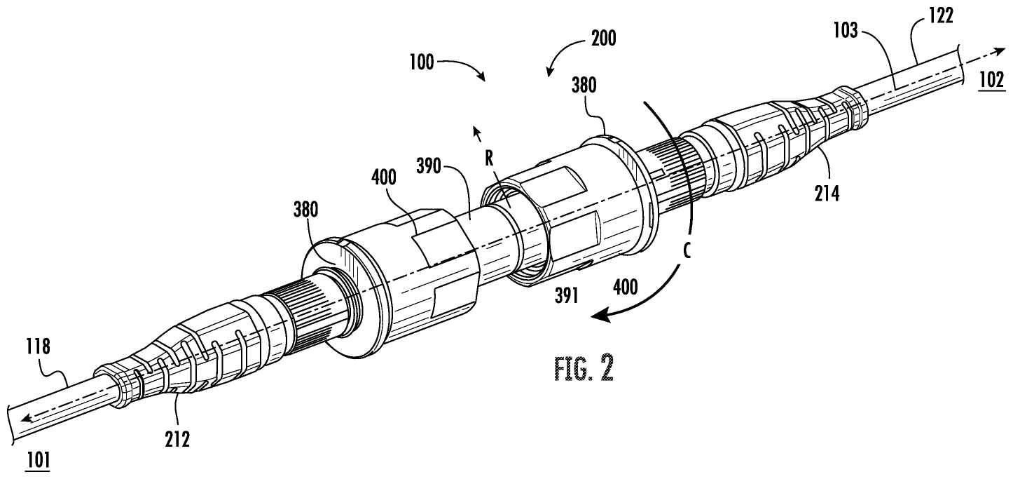

FIG. 2 is a perspective illustration of a fiber optic drop cable assembly in accordance with embodiments of the present disclosure;

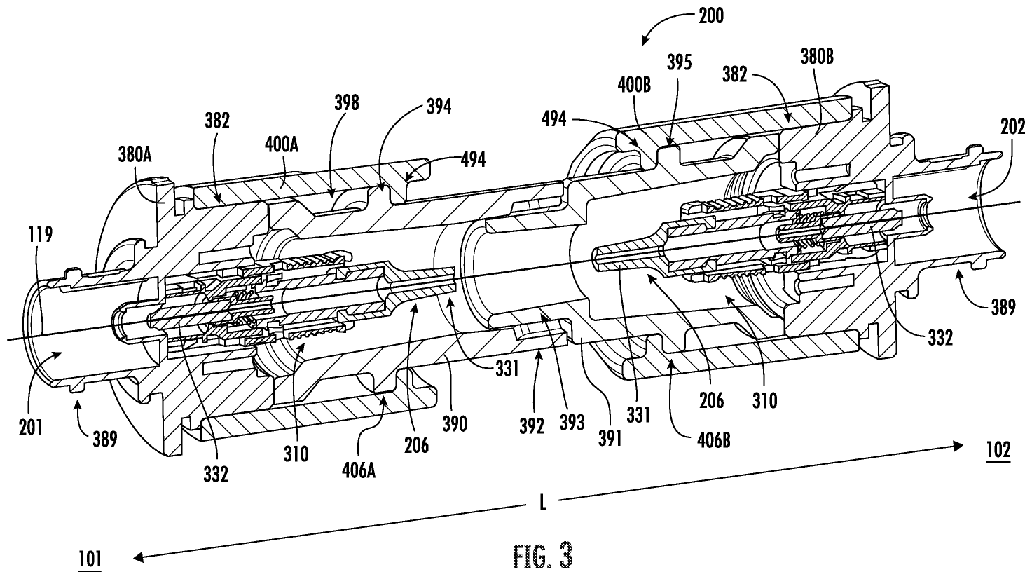

FIG. 3 is a cutaway perspective view of a fiber optic connector assembly in accordance with embodiments of the present disclosure;

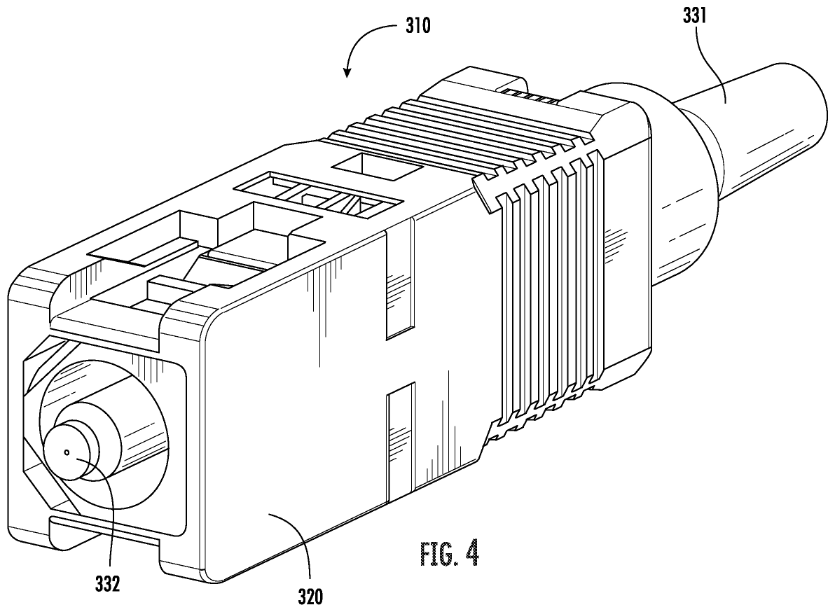

FIG. 4 is a cable axis view of the connector adapter of the fiber optic connector assembly in accordance with embodiments of the present disclosure;

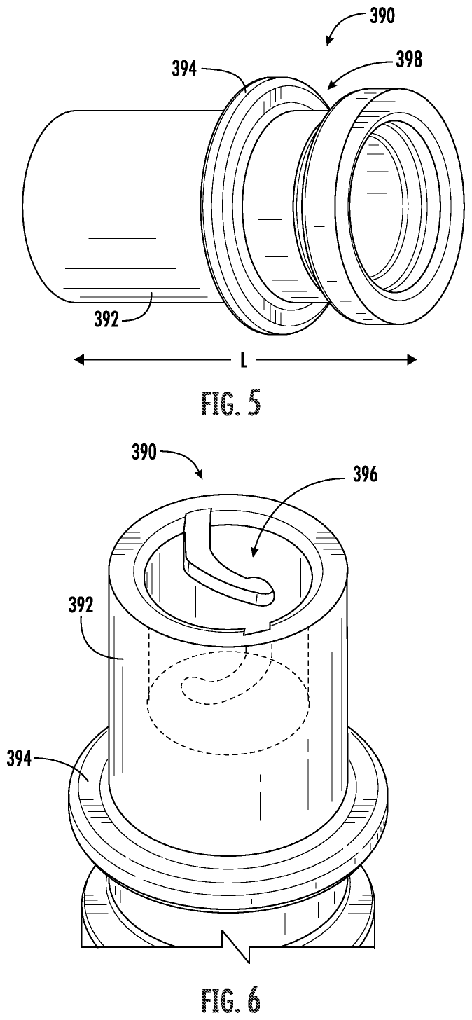

FIG. 5 is a perspective view of a first middle body of the fiber optic connector assembly in accordance with embodiments of the present disclosure;

FIG. 6 is a perspective view of a portion of the first middle body of the fiber optic connector assembly in accordance with embodiments of the present disclosure;

FIG. 7 is a perspective view of a second middle body of the fiber optic connector assembly in accordance with embodiments of the present disclosure;

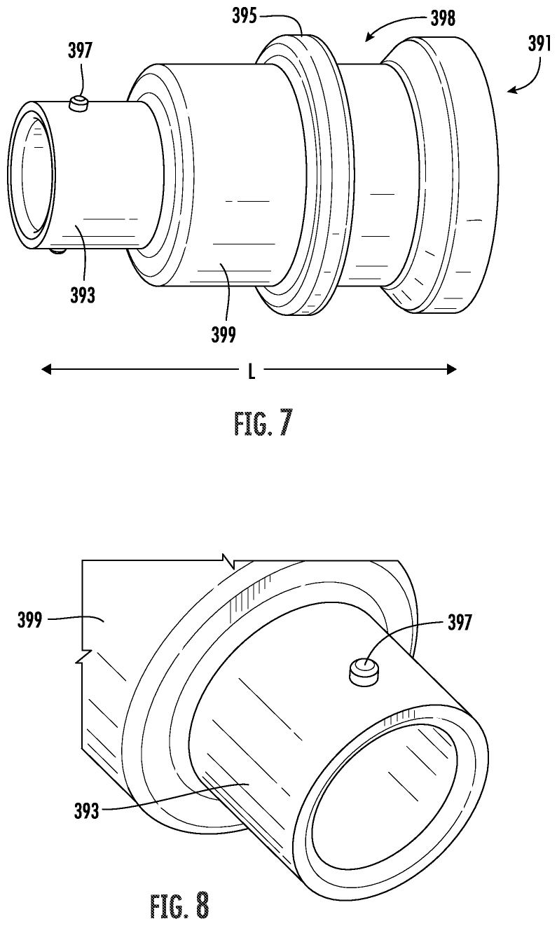

FIG. 8 is a perspective view of a portion of the second middle body of the fiber optic connector assembly in accordance with embodiments of the present disclosure;

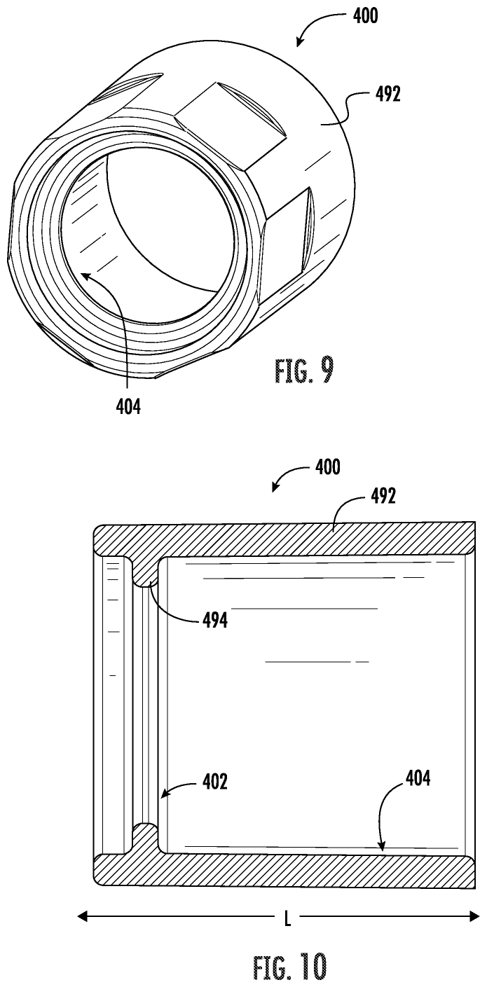

FIG. 9 is a perspective view of an outer body of the fiber optic connector assembly in accordance with embodiments of the present disclosure;

FIG. 10 is a cutaway side view of the outer body assembly of the fiber optic connector assembly in accordance with embodiments of the present disclosure;

FIG. 11 is a perspective view of a connector adapter of the fiber optic connector assembly in accordance with embodiments of the present disclosure;

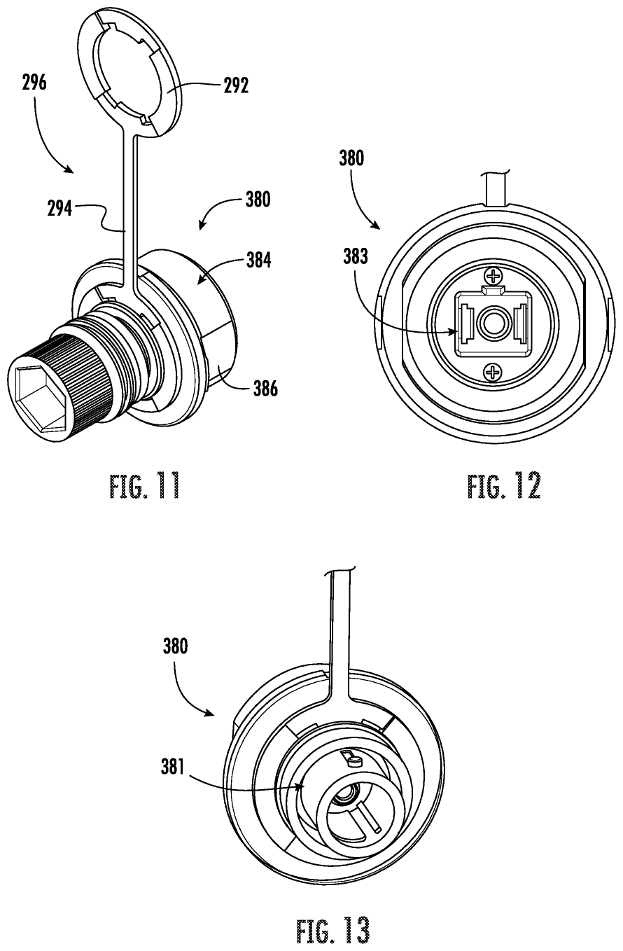

FIG. 12 is a perspective view of the connector adapter of the fiber optic connector assembly in accordance with embodiments of the present disclosure; and

FIG. 13 is a cutaway perspective view of a fiber optic connector assembly in accordance with embodiments of the present disclosure.

### DETAILED DESCRIPTION

Reference now will be made in detail to embodiments of the present cable support devices and assemblies, one or more examples of which are illustrated in the drawings. Each example is provided by way of explanation, rather than limitation of, the technology. In fact, it will be apparent to those skilled in the art that various modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents.

The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components.

As used herein, the terms “upstream” (or “forward”) and “downstream” (or “aft”) refer to the relative direction with respect to fluid flow in a fluid pathway. For example, “upstream” refers to the direction from which the fluid flows, and “downstream” refers to the direction to which the fluid flows. The term “radially” refers to the relative direction that is substantially perpendicular to an axial centerline of a particular component, the term “axially” or “longitudinally” refers to the relative direction that is substantially parallel and/or coaxially aligned to an axial centerline of a particular component and the term “circumferentially” refers to the relative direction that extends around the axial centerline of a particular component. Terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

As described further herein, embodiments of a fiber optic drop cable assembly and fiber optic connector assembly are provided. Embodiments of the drop cable assembly and connector assembly allow for a multi-fiber entry point to be divided and separated by a fan-out cable into a plurality of single-fiber output cables. Each single-fiber output cable is assembled to a hardened connector appropriate for outside plant (OSP) conditions, such as between a closure and a connection terminal at a delivery point (e.g., a subscriber). Embodiments of the drop cable assembly and connector assembly provided herein may be utilized in place of conventional drop terminal closures, such as may mount from a utility pole or other structure, to facilitate subscriber field connection. Still further, embodiments of the connector assembly allow for cable extension in OSP conditions. Furthermore, embodiments of the drop cable assembly and connector assembly provided herein allow for durability, reliability, and functionality required for OSP terminals, closures, underground volumes, pedestals, poles, aerial strands, or All-Dielectric Self-Supporting (ADSS) cables, while furthermore reducing size, weight, complexity, and spatial rigidness associated with structures for fiber to the X, or fiber in the loop, used in network architecture for a final distance (e.g., within approximately one mile) of a telecommunications network to the subscriber or connection terminal.

Referring now to FIG. 1, a portion of a fiber optic communications network 10 including a fiber optic distribution cable 12 is shown. One or more mid-span access locations are provided along the length of the distribution cable 12. The mid-span access location may be enclosed and protected from exposure to the environment by a conventional closure 14. The fiber optic communications network 10 may include a fiber optic distribution cable 12 having a plurality of mid-span access locations at branch points spaced along the length of the distribution cable, each providing access to at least one, and preferably, a plurality of optical fibers of the fiber optic network. Thus, in the embodiments shown, the distribution cable 12 may provide multiple locations for joining stub cables 24 of multi-port optical connection terminals 26 to the distribution cable 12 at each mid-span access location.

In the fiber optic network 10 as illustrated, pre-terminated optical fibers of the distribution cable 12 provided at the mid-span access location are routed out of the distribution cable and spliced to respective optical fibers of a stub cable 24 extending from a multi-port optical connection terminal 26. The optical fibers of the stub cable 24 may enter the closure 14 through a suitable cable port provided through an exterior wall, for example an end wall, of the closure 14. The stub cable 24 includes at least one, and preferably a plurality of optical fibers disposed within a protective cable sheath. The stub cable 24 may, for example, be any known fiber optic cable which includes at least one optical fiber and having a fiber count equal to or greater than that of a drop cable 16 to be connected to the multi-port optical connection terminal 26 and equal to or less than that of the distribution cable 12.

The stub cable 24 may extend from the closure 14 into a multi-fiber to single-fiber transition apparatus or terminal 26. The optical fibers of the stub cable 24 within the terminal 26 may be connectorized. One or more connectorized drop cables 16 may be interconnected with the connectorized optical fibers of the stub cable 24, i.e., in terminal 26. The drop cables 16 may include at least one single mode or multimode optical fiber of any type optically connected to a single fiber or multi-fiber optical connector in a conventional manner. The other ends of the drop cables 16 are optically connected to respective optical fibers of the communications network within an outside plant connection terminal 28 at a delivery point, such as an outside plant network access point (NAP) closure, local convergence cabinet (LCC), terminal, pedestal or network interface device (NID). As shown, one or more stub cables 24 extends from the closure 14 to a terminal 26 positioned at a distance from the mid-span access location, such as a telephone pole, hand-hole, vault or pedestal (not shown) in the fiber optic network 10. Each drop cable 16 extends from a terminal 26 to an outside plant connection terminal 28 located at a delivery point such as a subscriber home.

It should be understood that the present disclosure is not limited to the above-described embodiment of a fiber optic network 10, and rather that any suitable fiber optic network 10 is within the scope and spirit of the present disclosure.

Referring now to FIG. 2, an embodiment of a fiber optic drop cable assembly 100 (hereinafter, “cable assembly 100”) including a fiber optic connector assembly 200 (hereinafter, “connector assembly 200”) is provided. A reference cable axis 103 is provided extending between a first end 101 and a second end 102. The cable axis 103 corresponds to a longitudinal extension of an output cable 118, such as further described herein. In particular, the reference first end 101 corresponds to an end of the output cable 118 proximate to the terminal 26. The reference second end 102 corresponds to an end distal to the terminal 26 or proximate to the connection terminal 28. A reference radial direction R extends from cable axis 103. A reference circumferential direction C extends around cable axis 103. In further figures provided herein, a reference longitudinal direction L is provided corresponding substantially to a direction of extension of cable axis 103 from the first end 101 to the second end 102.

It should be appreciated that references herein to the first end 101 and the second end 102 at other components of the cable assembly 100 and the connector assembly 200 described herein provide relative positions, orientations, coordinates, or other spatial relationships at a first component, or at a first component relative to a second component. Accordingly, references to the first end 101 and the second end 102 at various components described herein do not necessarily require the first output cable 118, the second output cable 122, or other components of the cable assembly 100 for one skilled in the art to understand spatial relationships of other components described herein. Stated differently, references to the first end 101 and the second end 102 in regard to other components described herein are not intended to require the presence or inclusion of the first output cable 118, the second output cable 122, or other components of the cable assembly 100 for one skilled in the art to understand spatial relationships of other components described herein.

Embodiments of the cable assembly 100 may be included at embodiments of a fiber optic network, such as the fiber optic network 10 described in regard to FIG. 1. However, it should be understood that embodiments of the cable assembly 100 are not limited to the fiber optic network 10 described in regard to FIG. 1. Accordingly, the cable assembly 100 may be suitable for other configurations of fiber optic network within the scope and spirit of the present disclosure.

Various embodiments of output cable may include an outer jacket forming an outermost exterior surface of the output cable. The outer jacket may be formed from a suitable polymer, such as, but not limited to, polyethylene. The outer jacket may surround one or more buffer tubes. The buffer tube may be formed from one or more suitable polymer. The buffer tube may generally surround a central strength member. Strength fibers may surround the buffer tube within the outer jacket. Strength fibers may be formed from an aramid or other suitable material. In an embodiment, one or more optical fibers extends within an outer jacket of the output cable 118. Such structures for fiber optic cable are generally understood in the art, and may furthermore be understood to be substantively and functionally different from structures not intended for OSP conditions.

Referring now to FIG. 3, a cutaway perspective view of an embodiment of the fiber optic connector assembly 200 (hereinafter, “connector assembly 200”) is provided. The connector assembly 200 includes forms a first end opening 201 configured to receive a first optical fiber (e.g., first output cable 118) extending from the first end 101. The inner body assembly 200 forms a second end opening 202 configured to receive a second optical fiber (e.g., second output cable 122) from the second end 102.

Referring to FIGS. 3-12, the connector assembly 200 includes a connector jack body 380, an outer body 400, a first middle body 390, and a second middle body 391. In particular embodiments, the connector assembly 200 includes a first connector jack body 380A configured to couple to a first outer body 400A and the first middle body 390. In still particular embodiments, the connector assembly 200 includes a second connector jack body 380B configured to couple to a second outer body 400B and the second middle body 391. The first connector jack body 380A is configured to receive a first optical fiber (e.g., the first output cable 118) at the first end opening 201 and the second connector jack body 380B is configured to receive a second optical fiber (e.g., the second output cable 122) at the second end opening 202.

The middle bodies 390, 391 are each configured to extend along the longitudinal direction L through respective outer bodies 400. In a particular embodiment, the first middle body 390 is configured to extend through the first outer body 400A along the longitudinal direction L from the first end 101 toward the second end 102. Outer body 400 forms a substantially cylindrical body 492 extending along the longitudinal direction L, such as depicted in FIGS. 9-10. In particular, body 492 forms a tube having open ends allowing the fiber optic connector 310 and associated optical fibers, such as depicted via optical fiber 119, to extend along the longitudinal direction L through the body 492. A stop wall 494 extends inward along the radial direction R from the body 492 of the outer body 400. First middle body 390 forms a substantially cylindrical body 392 extending along the longitudinal direction L, such as depicted in FIGS. 5-6. Stop wall 494 is configured to abut against stop wall 394 extending outward along the radial direction R from the body 392 of the first middle body 390.

The first middle body 390 is configured to releasably attach to the respective outer body 400A. In particular, a threaded interface 406 may be formed at the first middle body 390 and the respective outer body 400. In still particular embodiments, such as depicted in FIGS. 9-10, the outer body forms a threaded interface 402 internal to the body 492. In still particular embodiments, such as depicted in FIGS. 5-6, first middle body 390 forms a threaded interface at wall 394 external to body 392. Threaded interface 406A is formed by the threaded coupling of the first middle body 390 and the first outer body 400A. Threaded interfaces 394, 402 correspond to one another such as to allow for selective attachment and detachment of respective pairs of first outer body 400A and first middle body 390 at threaded interface 406A (FIG. 3).

In a particular embodiment, the second middle body 391 is configured to extend through the second outer body 400B along the longitudinal direction L from the second end 102 toward the first end 101. Second middle body 391 forms a substantially cylindrical body 399 extending along the longitudinal direction L, such as depicted in FIGS. 7-8. Stop wall 494 at second outer body 400B is configured to abut against stop wall 395 extending outward along the radial direction R from the body 399 of the second middle body 391.

The second middle body 391 is configured to releasably attach to the respective outer body 400B. In particular, as described in regard to the first middle body 390, the threaded interface 406 may be formed at the second middle body 391 and the respective outer body 400B. In still particular embodiments, such as depicted in FIGS. 7-8, second middle body 391 forms a threaded interface at wall 395 external to body 399. The threaded interface 406B is formed by the threaded coupling of the second middle body 391 and the second outer body 400B. Threaded interfaces 395, 402 correspond to one another such as to allow for selective attachment and detachment of respective pairs of second outer body 400B and second middle body 391 at threaded interface 406B (FIG. 3).

Referring now to FIGS. 5-6, perspective views of an embodiment of the first middle body 390 are provided. Referring also to FIGS. 7-8, perspective views of an embodiment of the second middle body 391 are provided. As described above, each middle body 390, 391 includes respective stop walls 394, 395 configured to abut the stop wall 494 at respective outer bodies 400 through which each middle body 390, 391 extends along the longitudinal direction L. In particular, second middle body 391 forms an inner body 393 extended along the longitudinal direction L from body 399. Inner body 393 forms a substantially cylindrical tube configured to extend along the longitudinal direction L into body 392 at the first middle body 390. A notch 397 extends outward along the radial direction R from the inner body 393 and corresponds to a channel 396. Channel 396 is formed internal to body 392. In various embodiments, channel 396 is formed into body 392 extending along the longitudinal direction L and circumferential direction C (e.g., a partial helical contour). Second middle body 391 is configured to extend into first middle body 390 along the longitudinal direction L. In particular, channel 396 extends from a distal end (e.g., distal to the connector jack body 380A). As second middle body 391 is extended into first middle body 390, notch 397 is configured to route into channel 396 and prevent rotation along circumferential direction C and movement along longitudinal direction L of the middle bodies 390, 391 relative to one another.

Accordingly, the first middle body 390 may form a female connection forming an opening configured to receive the second middle body 391 as a male connector. Embodiments depicted herein include the first middle body 390 positioned proximate to the first end 101 and the second middle body 391 configured proximate to the second end 102. However, it should be appreciated that embodiments of the connector assembly 200 may be configured to have the first middle body 390 positioned proximate to the second end 102 and the second middle body 391 configured proximate to the first end 101.

Referring to FIGS. 5-8, each of the middle bodies 390, 391 may form a trough or groove 398 between the stop wall 394, 395 and an outside end (i.e., an end proximate along the longitudinal direction L to which the connector jack body 380 attaches to the respective middle body 390, 391). A sealant, putty, epoxy, or other appropriate sealing material may be disposed in the groove 398. When outer body 400 is attached to the respective middle bodies 390, 391, a cavity is formed at the groove 398 between the outer body 400 and each respective middle body 390, 391. The cavity is further formed between respective stop wall 394, 395 and outside ends of the middle body 390, 391.

Each connector jack body 380 is configured to releasably attach to respective middle bodies 390, 391 and outer bodies 400. In particular, a threaded interface 382 may be formed at the outer body 400 and the respective connector jack 380. In still particular embodiments, such as depicted in FIGS. 9-10, the outer body 400 forms a threaded interface 404 internal to the body 492. In still particular embodiments, such as depicted in FIGS. 11-13, connector jack body 380 forms a threaded interface 384 external to body 386 extending along the longitudinal direction L. Threaded interfaces 384, 404 correspond to one another such as to allow for selective attachment and detachment of respective pairs of outer body 400 and connector jack 380 at threaded interface 382 (FIG. 3). Outer body 400 allows respective middle bodies 390, 391 to attach to respective connector jack bodies 380 without twisting the optical fiber extended between connector jack bodies 380A, 380B.

Referring now to FIGS. 11-13, exemplary embodiments of a fiber optic jack adapter or connector jack body 380 are provided. The connector jack body 380 includes a terminal 383 configured to receive a fiber optic connector 310 (FIG. 4). Connector jack body 380 may include a twist lock nose 381 for connecting terminated ends.

Referring briefly to FIG. 4, the fiber optic connector 310 includes a connector body 320 configured to support a connecting fiber 331 extending between pairs of fiber optic connectors 310 at respective pairs of connector jack bodies 380A, 380B. Connector body 320 furthermore supports a ferrule end portion 332 configured to receive a first optical fiber (e.g., first output cable 118) and second optical fiber (e.g., from second output cable 122). In an embodiment such as depicted in FIG. 4, fiber optic connector 310 may be configured as an SC connector or equivalent. In other embodiments, fiber optic connector 310 may be configured as an ST connector, an LC connector, or any other appropriate type of telecommunications or fiber optic connector, or any other appropriate type of single fiber connector.

Referring back to FIGS. 11-13, a restraining device 296 may be attached to the respective first and second connector jack bodies 380A, 380B or other portion of the cable assembly 100 or connector assembly 200. Restraining device 296 includes one or more rings 292 connected to a strap 294. Restraining device 296 may form a lanyard configured to retain the connector assembly 200 or cable assembly 100 to the second output cable 122 (FIG. 2).

Embodiments of the connector assembly 200 provided herein expand mounting options between a module or closure 14 and an OSP location, such as a drop cable 16 or connection terminal 28. Such expanded mounting options allow for reduced cable routing footprint and allows for cable routing to be stored in smaller spaces in contrast to known multi-port connection terminals. Embodiments of the connector assembly 200 may additionally, or alternatively, be utilized as a cable extension device.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A fiber optic connector assembly, the fiber optic connector assembly defining a first end and a second end each separated along a longitudinal direction corresponding to a longitudinal extension of a cable, the fiber optic connector assembly comprising:
a first middle body extending along the longitudinal direction, the first middle body forming open ends through which an optical fiber is extendable along the longitudinal direction;
a second middle body extending along the longitudinal direction, the second middle body forming open ends through which the optical fiber is extendable along the longitudinal direction, the second middle body forming an inner body configured to extend into the first middle body;
a connector body configured to retain a fiber optic connector along the longitudinal direction, the connector body coupled respectively to the first middle body and the second middle body;
an outer body extending along the longitudinal direction, the outer body configured to couple to the connector body and respective first middle body and second middle body, the outer body configured to surround a mating interface at which the connector body abuts to respective first middle body and second body.

2. The fiber optic connector assembly of claim 1, wherein each of the first middle body and the second middle body form a stop wall extending outward along a radial direction, and wherein the outer body forms a stop wall extending inward along the radial direction, wherein the outer body is configured to abut each respective first middle body and second middle body at respective stop walls.

3. The fiber optic connector assembly of claim 2, wherein a threaded interface is formed at the stop walls between the outer body and respective first middle body and second middle body.

4. The fiber optic connector assembly of claim 2, wherein the first middle body and the second middle body each form a groove between the stop wall and an outside end proximate to the connector body.

5. The fiber optic connector assembly of claim 4, wherein a cavity is formed between the outer body and respectively coupled first middle body and second middle body.

6. The fiber optic connector assembly of claim 2, wherein the first middle body and the second middle body each form a flange extending along the longitudinal direction, wherein the flange extends along a radial direction greater than a substantially cylindrical body extending along the longitudinal direction.

7. The fiber optic connector assembly of claim 1, wherein the outer body and the connector body together form a threaded interface at which the outer body and the connector body are coupled.

8. The fiber optic connector assembly of claim 1, wherein the connector body is a female connector configured to receive a male connector from a fiber optic cable.

9. The fiber optic connector assembly of claim 1, wherein a channel is formed internal to the first middle body, and wherein a notch extends outward along a radial direction from the inner body at the second middle body, the channel at the first middle body configured to receive the notch at the second middle body.

10. A fiber optic cable assembly, the fiber optic cable assembly defining a first end and a second end each separated along a longitudinal direction, the fiber optic cable assembly comprising:
a first fiber optic cable extending from the first end;
a second fiber optic cable extending from the second end;
a connector assembly configured to receive the first fiber optic cable at the first end and the second fiber optic cable at the second end, the connector assembly comprising a first middle body, a second middle body, a first connector body, a second connector body, a first outer body, and a second outer body,
wherein the first middle body forms open ends through which an optical fiber is extendable along the longitudinal direction,
wherein the second middle body forms open ends through which the optical fiber is extendable along the longitudinal direction, the second middle body forming an inner body configured to extend into the first middle body and couple to the first middle body,
wherein the first connector body is configured to retain a first fiber optic connector along the longitudinal direction, the first connector body coupled to the first middle body,
wherein the first outer body is configured to couple to the first connector body and the first middle body, the first outer body configured to surround a first mating interface at which the first connector body abuts to the first middle body,
wherein the second connector body is configured to retain a second fiber optic connector along the longitudinal direction, the second connector body coupled to the second middle body,
wherein the second outer body is configured to couple to the second connector body and the second middle body, the second outer body configured to surround a second mating interface at which the second connector body abuts to the second middle body.

11. The fiber optic cable assembly of claim 10, wherein the first middle body and the second middle body each form a stop wall extending outward along a radial direction, and wherein the first outer body and the second outer body each form a stop wall extending inward along the radial direction, wherein the first outer body is configured to abut the first middle body at the respective stop wall at the first middle body, and wherein the second outer body is configured to abut the second middle body at the respective stop wall at the second middle body.

12. The fiber optic cable assembly of claim 11, wherein a threaded interface is formed at the stop walls between the outer body and respective first middle body and second middle body.

13. The fiber optic cable assembly of claim 11, wherein the first middle body and the second middle body each form a groove between the stop wall and an outside end proximate to the connector body.

14. The fiber optic cable assembly of claim 13, wherein a cavity is formed between the outer body and respectively coupled first middle body and second middle body.

15. The fiber optic cable assembly of claim 11, wherein the first middle body and the second middle body each form a flange extending along the longitudinal direction, wherein the flange extends along a radial direction greater than a substantially cylindrical body extending along the longitudinal direction.

16. The fiber optic cable assembly of claim 10, wherein the outer body and the connector body together form a threaded interface at which the outer body and the connector body are coupled.

17. The fiber optic cable assembly of claim 10, wherein the connector body is a female connector configured to receive a male connector from a fiber optic cable.

18. The fiber optic cable assembly of claim 10, wherein a channel is formed internal to the first middle body, and wherein a notch extends outward along a radial direction from the inner body at the second middle body, the channel at the first middle body configured to receive the notch at the second middle body.

19. The fiber optic cable assembly of claim 10, wherein the first and second fiber optic connectors is an SC connector, an ST, connector, an LC connector, or combinations thereof.

20. The fiber optic cable assembly of claim 10, wherein the first fiber optic cable and the second fiber optic cable are drop cables extending between a multi-port optical connection terminal and an outside plant connection terminal.
